(19) United States
(12) Patent Application Publication
(10) Pub. No.: US 2006/0228617 A1
(43) Pub. Date: Oct. 12, 2006

(54) Fuel cell stack

(76) Inventors: Jin-Hong An, Suwon-si (KR); Ri-A Ju, Suwon-si (KR); Sang-Hyeon Choi, Yongin-si (KR); Eun-Suk Cho, Suwon-si (KR); Jong-Ki Lee, Suwon-si (KR); Jun-Won Suh, Suwon-si (KR); Dong-Yun Lee, Yongin-si (KR); Won-Hyouk Jang, Suwon-si (KR)

Correspondence Address: CHRISTIE, PARKER & HALE, LLP, PO BOX 7068, PASADENA, CA, 91109-7068, US

(21) Appl. No.: 11/388,878

(22) Filed: Mar. 23, 2006

(30) Foreign Application Priority Data
Apr. 8, 2005 (KR) 10-2005-0029465

(51) Int. Cl. H01M 8/02; H01M 8/10; H01M 8/06

(52) U.S. Cl. 429/38; 429/30; 429/19

(57) ABSTRACT

A fuel cell stack includes a first separator and a second separator, each separator having raised portions and channel portions on a first side and a second side, the channel portions on the first side being opposite the raised portions on the second side and the channel portions on the second side being opposite the raised portions on the first side. The stack also includes a membrane-electrode assembly located between the first separator and the second separator, and closely contacting the raised portions of the first side of the first separator and the raised portions of the second side of the second separator.

### CROSS-REFERENCE TO RELATED APPLICATION

This application claims priority to and the benefit of Korean Patent Application No. 10-2005-0029465, filed in the Korean Intellectual Property Office on Apr. 8, 2005, the entire content of which is incorporated herein by reference.

### BACKGROUND OF THE INVENTION

(a) Field of the Invention

The present invention relates to a fuel cell stack, and more particularly, to a separator having enhanced structures of hydrogen and oxygen transport channels.

(b) Description of the Related Art

As is well known, a fuel cell is an electricity generating system for directly converting chemical reaction energy of hydrogen, contained in a hydrocarbon material such as methanol, ethanol, and natural gas, and oxygen, separately supplied, into electrical energy.

A recently developed polymer electrolyte membrane fuel cell (PEMFC) has excellent output characteristics, a low operation temperature, and fast starting and response characteristics. In addition, such a fuel cell advantageously has a wide range of applications including applications as a mobile power source for vehicles, a distributed power source for homes or buildings, and a small-sized power source for electronic apparatuses.

A typical PEMFC system basically includes a stack and a reformer. The stack constitutes a main body of the fuel cell for generating the electrical energy through reaction of hydrogen and oxygen, and the reformer reforms the fuel to generate the hydrogen and supplies the hydrogen to the stack.

Direct oxidation fuel cell schemes, such as a direct methanol fuel cell (DMFC) scheme, directly supply fuel to a stack and electrical energy is generated through an electro-chemical reaction of the fuel and oxygen. Unlike fuel cell schemes using a reformer, fuel cell systems using the DMFC scheme do not require reformers.

FIG. 4 is a partial cross sectional view showing a stack in a conventional fuel cell system.

Referring to FIG. 4, the stack includes electricity generators 16 in which separators 13 and 13′ (referred to as “bipolar plates” in the art) are disposed in close contact with both surfaces of a membrane-electrode assembly (MEA) 11. In general, the stack is constructed with a plurality of the electricity generators 16.

In the electricity generators 16, the separators and 13 and 13′ closely contact both surfaces of the membrane-electrode assembly 11 and have a hydrogen channel 15, that is, a hydrogen transport channel for supplying hydrogen to an anode electrode of the membrane-electrode assembly 11 and an oxygen channel 17, that is, an oxygen transport channel for supplying oxygen to a cathode electrode of the membrane-electrode assembly 11. Here, the membrane-electrode assembly 11 includes a membrane and the anode electrode and the cathode electrode are disposed on both surfaces of the membrane, but these components are not shown in detail in the figure for convenience.

The hydrogen channel 15 and the oxygen channel 17 may be constructed with channels 19 and 19′ which are disposed between a plurality of ribs 18 and 18′ formed with an arbitrary pitch on both surfaces of the separators 13 and 13′.

A hydrogen channel 15 is disposed on one surface and an oxygen channel 17 is disposed on the other surface of each of the separators 13 and 13′. Portions of the separators 13 and 13′ disposed between the hydrogen channels 15 and the oxygen channels 17 constitute barriers a having a predetermined thickness.

The conventional separators are made of graphite or a carbon composite material, which have a unique characteristic in that gases can penetrate the material.

Therefore, in a case where the separators 13 and 13′ are made of such a material, the hydrogen and the oxygen passing through the hydrogen channel 15 and the oxygen channel 17 may penetrate through the barriers a, so that the hydrogen and the oxygen may mix.

Accordingly, in the art, the separators 13 and 13′ are constructed with a thickness above a minimum thickness t2, typically, 0.4 mm, so that the hydrogen and the oxygen cannot penetrate the barriers a.

Since the separators 13 and 13′ are constructed by disposing the hydrogen channels 15 and the oxygen channels 17 next to, or “opposite” each other with the barriers a interposed between them, a minimum margin of the thickness t2 is needed to avoid the aforementioned problem. Therefore, there is a limitation to reducing a total thickness t1 of the separators 13 and 13′, and so it is difficult to decrease the thickness of the stack.

### SUMMARY OF THE INVENTION

A fuel cell stack according to one embodiment includes a first separator and a second separator, each separator having raised portions and channel portions on a first side and a second side, the channel portions on the first side being opposite the raised portions on the second side and the channel portions on the second side being opposite the raised portions on the first side. The fuel cell stack also includes a membrane-electrode assembly located between the first separator and the second separator, and closely contacting the raised portions of the first side of the first separator and the raised portions of the second side of the second separator.

In another embodiment, each of the channel portions has a transverse cross section having a rounded shape. Further, if thickness distances between the raised portions on the first side of the separators and the raised portions on the second side of the separators are first thicknesses T1, thickness distances between the raised portions on the first side and the channel portions on the second side are thicknesses T2, and distances between tangential lines of the channel portions on the first side and tangential lines of the channel portions on the second side are third thicknesses T3, the thicknesses T1, T2, and T3 may have the following relation: T1>T2>T3.

In another embodiment, locations of the channel portions on the first side of each of the separators alternate from locations of the channel portions on the second side of each of the separators. The channel portions formed on the first side of each of the separators and the channel portions formed on the second side of each of the separators may also be disposed with a same pitch.

The channel portions may be constructed by forming grooves on the separators, and the raised portions may be constructed as portions of the main bodies of the separators disposed between the channel portions.

The separators may be made of graphite or a compression molded carbon composite material.

The channel portions on the first side of the separators may constitute hydrogen transport channels, and the channel portions on the second side of the separators may constitute oxygen transport channels,

In another embodiment of the invention, a fuel cell system may include a fuel cell stack generating electrical energy through a reaction of hydrogen and oxygen, a fuel supply unit coupled to the fuel cell stack for supplying hydrogen, and an oxygen supply unit coupled to the fuel cell stack for supplying oxygen. The fuel cell stack may be similar as described above.

### BRIEF DESCRIPTION OF THE DRAWINGS

The above and other features and aspects of the present invention will become more apparent by describing an exemplary embodiment thereof with reference to the attached drawings, in which:

FIG. 1 is a schematic constructional view showing a fuel cell system according to an embodiment of the present invention;

FIG. 2 is a partial cross sectional view showing a fuel cell stack according to the embodiment shown in FIG. 1;

FIG. 3 is a partial enlarged cross sectional view showing a separator of FIG. 2; and

FIG. 4 is a partial cross sectional view showing a conventional fuel cell stack.

### DETAILED DESCRIPTION OF THE EMBODIMENTS

Hereinafter, an exemplary embodiment of the present invention will be described in detail with reference to the attached drawings such that the present invention can be easily put into practice by those skilled in the art. However, the present invention is not limited to the exemplary embodiment, but may be embodied in various forms.

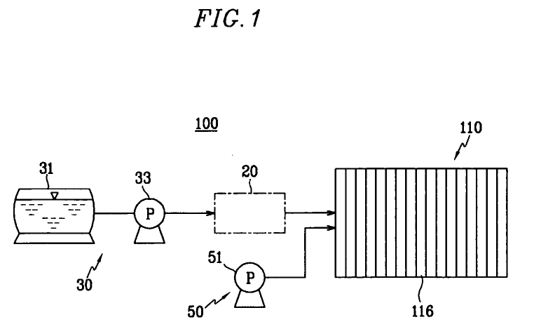

Referring to FIG. 1, a fuel cell system 100 according to an embodiment of the present invention has a polymer electrode membrane fuel cell (PEMFC) scheme in which hydrogen is generated by reforming fuel and electrical energy is generated through an electro-chemical reaction of the hydrogen and oxygen.

The fuel used for the fuel cell system 100 may include a liquid or gas hydrogen-containing fuel such as methanol, ethanol, or natural gas. In the embodiment shown, a liquid fuel such as methanol is exemplified.

In addition, in the fuel cell system 100, as an oxidant reacting with hydrogen, oxygen stored in an additional storage device or natural air containing oxygen may be used. In the embodiment shown, natural air is exemplified.

The fuel cell system 100 includes: electricity generators 116 for generating electrical energy through a reaction of hydrogen and oxygen; a reformer 20 for generating hydrogen from a fuel through a chemical catalytic reaction using thermal energy and supplying the hydrogen to the electricity generators 116; a fuel supply unit 30 for supplying the fuel to the reformer 20; and an air supply unit 50 for supplying air to the electricity generators 116.

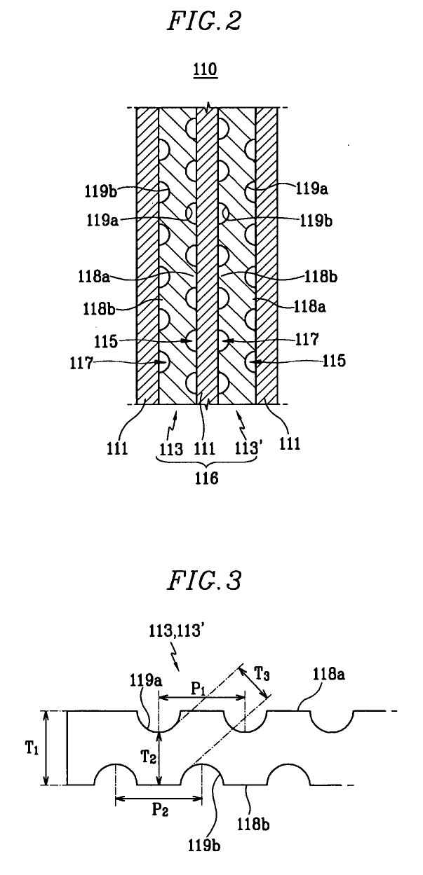

Each of the electricity generators 116 is a minimum unit of a fuel cell for generating the aforementioned electrical energy. A stack 110 is a stacked structure constructed by stacking a plurality of the electricity generators 116. The stack 110 will be described later in detail with reference to FIGS. 2 and 3.

The reformer 20 may be constructed with a typical structure for generating hydrogen from fuel through a catalytic reaction such as a steam reforming reaction, a partial oxidation reaction, or an auto-thermal reaction.

The fuel supply unit 30 for supplying the fuel to the reformer 20 includes a fuel tank 31 for storing the fuel and a fuel pump 33 for discharging the fuel from the fuel tank 31 and supplying the fuel to the reformer 20.

The air supply unit 50 includes an air pump 51 for sucking air at a predetermined pumping power and supplying the air to the electricity generators 116 of the stack 110.

As an alternative example, instead of the aforementioned air pump 51, the air supply unit 50 may include a fan.

Although the fuel cell shown in FIG. 1 has a PEMFC scheme, the invention is not limited thereto. The fuel cell system to which the present invention is applied may be constructed by using a direct oxidation fuel cell scheme such as a direct methanol fuel cell (DMFC) scheme in which fuel is directly supplied to electricity generators of a stack and electrical energy is generated through an electrochemical reaction of the fuel and oxygen.

Unlike the polymer electrolyte fuel cell system according to the embodiment shown in FIG. 1, such a direct oxidation fuel cell system does not require the reformer 20.

A construction of the fuel cell stack 110 according to one embodiment of the present invention will be described in detail. FIG. 2 is a partial cross sectional view showing the fuel cell stack 110 according to one embodiment of the present invention.

Referring to FIG. 2, as described above, the fuel cell stack 110 according to this embodiment includes electricity generators 116, each of which is a minimum unit for generating electrical energy through a reaction of hydrogen and oxygen.

Each of the electricity generators 116 includes a membrane-electrode assembly (MEA) 111 and separators 113 and 113′ closely contacting surfaces of the MEA 111.

Although not shown in the figure, the MEA 111 includes an electrolyte membrane and anode and cathode electrodes that are disposed on respective surfaces of the electrolyte membrane.

The anode electrode receives the reforming gas through the separator 113. The anode electrode is constructed with a catalyst layer for promoting the decomposition of the reforming gas into electrons and hydrogen ions and a gas diffusion layer (GDL) for promoting transportation of the reforming gas.

The cathode electrode receives the air through the separator 113′. The cathode electrode is constructed with a catalyst layer for promoting reaction of the electrons, hydrogen ions, and oxygen contained in the air to generate water. The cathode electrode also includes a gas diffusion layer for promoting transportation of the oxygen.

In this embodiment, each of the separators 113 and 113′ has a hydrogen transport channel 115 disposed on one surface thereof closely contacting an anode electrode of an MEA 111 and an oxygen transport channel 117 disposed on the other surface closely contacting a cathode of an adjacent MEA 111.

In this embodiment, the hydrogen transport channel 115 may be constructed with first, in this case raised, portions 118a of the separators 113 and 113′ closely contacting the anode electrode of the MEA 111 and second, in this case channel, portions 119a of the separators 113 and 113′ separated from the anode electrode of the MEA 111. In the context of this disclosure, the term “raised” refers to having a different level or height in relation to the “channel” portions, such as is shown in FIGS. 1-3.

In this embodiment, the channel portions 119a may be constructed by forming a plurality of grooves with a suitable pitch, which may be a predetermined or an arbitrary pitch, on one surface of the separators 113 and 113′. The raised portions 118a may be constructed as portions of the main bodies of the separators 113 and 113′ disposed between the grooves.

Similarly, the oxygen transport channel 117 may be constructed with raised portions 118b of the separators 113 and 113′ closely contacting the cathode electrode of the MEA 111 and channel portions 119b of the separators 113 and 113′ separated from the cathode electrode of the MEA 111.

In this embodiment, the channel portions 119b are constructed by forming a plurality of grooves with a pitch on the other surface of the separators 113 and 113′ from the channel portions 119a, and the raised portions 118b may be constructed as portions of the main bodies of the separators 113 and 113′ disposed between the grooves.

In this embodiment, the grooves for constructing the channel portions 119a and 119b have a shape of straight line, and alternating ends of the grooves are connected.

In addition to the basic structures of the separators 113 and 113′, the hydrogen transport channels 115 and the oxygen transport channels 117 are constructed by disposing the raised portions 118a and 118b with the channel portions 119b and 119a, respectively, on opposite surfaces of each of the separators 113 and 113′.

The first portion 118a is disposed opposite to the second portion 119a on each of the separators 113 and 113′. Likewise, the first portion 118b is disposed opposite to the second portion 119b on each of the separators 113 and 113′.

The hydrogen transport channel 115 and the oxygen transport channel 117 can be formed by using an etching process during the formation of the separators 113 and 113′ with graphite material.

Alternatively, the hydrogen transport channel 115 and the oxygen transport channel 117 may be made of a powder-state carbon composite material by using a compression molding process.

More specifically, in the construction of the hydrogen transport channel 115 and the oxygen transport channel 117, the channel portions 119a and 119b constituting the hydrogen transport channel 115 and the oxygen transport channel 117 are disposed alternately in the same period on both surfaces of the separators 113 and 113′.

Here, the channel portions 119a and 119b have the same pitch, P1 and P2 in FIG. 3.

Moreover, in this embodiment, the channel portions 119a and 119b, substantially constituting the hydrogen transport channel 115 and the oxygen transport channel 117, have a transverse cross section with a rounded shape.

Due to the shape, it is possible to smooth the flow of the hydrogen and the air passing through the hydrogen transport channel 115 and the oxygen transport channel 117. Namely, due to the structures of the hydrogen transport channel 115 and the oxygen transport channel 117 having the rounded shapes, there are no angled portions interfering with the flow of the hydrogen and the oxygen passing through the channels, so that it is possible to smooth the flow of the hydrogen and the oxygen.

A distance along a thickness direction, as shown in FIG. 3, is referred to herein as a “thickness distance.” In this embodiment, the separators 113 and 113′ have the following relation with respect to thicknesses thereof. Referring to FIG. 3, thickness distances between the raised portions 118a and 118b of the separators 113 and 113′ are assumed to be the first thickness T1. Thickness distances between the raised portions 118b and channel portions 119a or between the raised portions 118a and channel portions 119b are assumed to be the second thickness T2, and thickness distances between tangential lines of the channel portions 119a and 119b are assumed to be third thickness T3. The thicknesses T1, T2, and T3 have the following relation: T1>T2>T3.

In one embodiment, T3 is maintained at a distance of 0.4 mm or more. In a case where the separators 113 and 113′ are made of graphite or a carbon composite material, it is desirable to obtain a minimum thickness capable of preventing the hydrogen passing through the hydrogen transport channel 115 from penetrating into the oxygen transport channel 117 and/or preventing the air passing through the oxygen transport channel 117 from penetrating into the hydrogen transport channel 115.

According to the aforementioned embodiments, the separators 113 and 113′ can satisfy the restriction involved with the characteristics of the material, that is, the restriction that the thickness between the hydrogen transport channel 115 and the oxygen transport channel 117 should be maintained at a distance of 0.4 mm or more, while a total thickness of the separators 113 and 113′ does not increase.

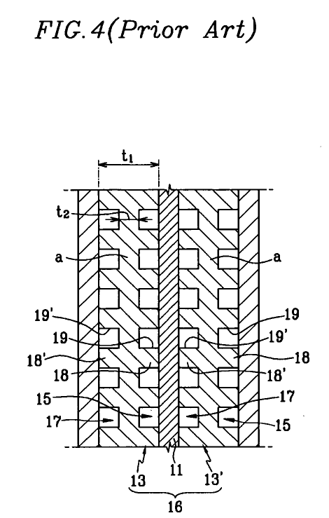

In a case where the separators 113 and 113′ of FIG. 3 and the conventional separators 13 and 13′ of FIG. 4 are applied to the same type of fuel cell stacks, the conventional separators 13 and 13′ require a total thickness t1 thereof with a thickness t2 of a portion a of 0.4 mm or more to satisfy the aforementioned restriction.

In contrast, the separators 113 and 113′ according to the embodiment described in FIGS. 1-3 require a total thickness T1 thereof with the thickness T3 of 0.4 mm to satisfy the aforementioned restriction. Therefore, the total thickness T1 can be smaller than the total thickness t1 of the conventional separators 13 and 13′.

By doing so, while good characteristics are maintained, a total thickness of the separators 113 and 113′ according to this embodiment can be reduced in comparison to separators of a conventional fuel cell system.

Operations of the fuel cell system 100 using the fuel cell stack according to the embodiment of the present invention will now be described.

Referring to FIGS. 1-3, the reformer 20 reforms the fuel supplied from the fuel tank 31 to generate hydrogen, and the hydrogen is supplied to the stack 110. At the same time, the air pump 51 supplies air to the stack 110.

The hydrogen and air supplied to the stack 110 are transported to the separators 113 and 113′ along the hydrogen transport channel 115 and the oxygen transport channel 117, respectively. During the transportation of the hydrogen and air, an electrochemical reaction thereof occurs in the electricity generators 116, so that the electricity generators 116 can generate a predetermined amount of electrical energy.

As described above, according to one embodiment of the present invention, structures of a hydrogen transport channel and an oxygen transport channel of the separators are enhanced while still preventing hydrogen and oxygen from penetrating and mixing. A total thickness of the separators may still be reduced in comparison to a conventional structure. As a result, it is possible to reduce a total volume of a stack, and to implement a fuel cell system having a compact structure.

In addition, according to embodiments of the present invention, since cross sections of the hydrogen transport channel and the oxygen transport channel of the separators are constructed to have a rounded shape, flow of hydrogen and air can be smoothed, so that it is possible to improve performance of the stack.

While the invention has been described in connection with certain exemplary embodiments, it is to be understood by those skilled in the art that the invention is not limited to the disclosed embodiments, but, on the contrary, is intended to cover various modifications included within the sprit and scope of the appended claims and equivalents thereof.

What is claimed is:

1. A fuel cell stack, comprising:
a first separator and a second separator, each separator having raised portions and channel portions on a first side and a second side, the channel portions on the first side being opposite the raised portions on the second side and the channel portions on the second side being opposite the raised portions on the first side; and
a membrane-electrode assembly located between the first separator and the second separator, and closely contacting the raised portions of the first side of the first separator and the raised portions of the second side of the second separator.

2. The fuel cell stack of claim 1, wherein each of the channel portions has a transverse cross section having a rounded shape.

3. The fuel cell stack of claim 1, wherein if thickness distances between the raised portions on the first side of the separators and the raised portions on the second side of the separators are first thicknesses T1, thickness distances between the raised portions on the first side and the channel portions on the second side are thicknesses T2, and distances between tangential lines of the channel portions on the first side and tangential lines of the channel portions on the second side are third thicknesses T3, the thicknesses T1, T2, and T3 have the following relation: T1>T2>T3.

4. The fuel cell stack of claim 1, wherein locations of the channel portions on the first side of each of the separators alternate from locations of the channel portions on the second side of each of the separators.

5. The fuel cell stack of claim 4, wherein the channel portions formed on the first side of each of the separators and the channel portions formed on the second side of each of the separators are disposed with a same pitch.

6. The fuel cell stack of claim 1, wherein the channel portions are constructed by forming grooves on the separators, and the raised portions are constructed as portions of the main bodies of the separators disposed between the channel portions.

7. The fuel cell stack of claim 1, wherein the separators are made of graphite.

8. The fuel cell stack of claim 1, wherein the separators are made of a compression molded carbon composite material.

9. The fuel cell stack of claim 1, wherein the channel portions on the first side of the separators constitute hydrogen transport channels, and the channel portions on the second side of the separators constitute oxygen transport channels,

10. A fuel cell system comprising:
a fuel cell stack generating electrical energy through a reaction of hydrogen and oxygen;
a fuel supply unit coupled to the fuel cell stack for supplying hydrogen; and
an oxygen supply unit coupled to the fuel cell stack for supplying oxygen,
wherein the fuel cell stack comprises:
a first separator and a second separator, each separator having raised portions and channel portions on a first side and a second side, the channel portions on the first side being opposite the raised portions on the second side and the channel portions on the second side being opposite the raised portions on the first side; and
a membrane-electrode assembly located between the first separator and the second separator, and closely contacting the raised portions of the first side of the first separator and the raised portions of the second side of the second separator.

11. The fuel cell system of claim 10, wherein each of the channel portions has a transverse cross section having a rounded shape.

12. The fuel cell system of claim 10, wherein if thickness distances between the raised portions on the first side of the separators and the raised portions on the second side of the separators are first thicknesses T1, thickness distances between the raised portions on the first side and the channel portions on the second side are thicknesses T2, and distances between tangential lines of the channel portions on the first side and tangential lines of the channel portions on the second side are third thicknesses T3, the thicknesses T1, T2, and T3 have the following relation: T1>T2>T3.

13. The fuel cell system of claim 10, wherein locations of the channel portions on the first side of each of the separators alternate from locations of the channel portions on the second side of each of the separators.

14. The fuel cell system of claim 13, wherein the channel portions formed on the first side of each of the separators and the channel portions formed on the second side of each of the separators are disposed with a same pitch.

15. The fuel cell system of claim 10, wherein the channel portions are constructed by forming grooves with a first pitch on the separators, and the raised portions are constructed as portions of the main bodies of the separators disposed between the channel portions.

16. The fuel cell system of claim 10, wherein the separators are made of graphite.

17. The fuel cell system of claim 10, wherein the separators are made of a compression molded carbon composite material.

18. The fuel cell system of claim 10, wherein the channel portions on the first side of the separators constitute hydrogen transport channels coupled to the fuel supply unit, and the channel portions on the second side of the separators constitute oxygen transport channels coupled to the oxygen supply unit.

19. The fuel cell system of claim 10, further comprising a reformer coupled to the fuel supply unit and the fuel cell stack for generating hydrogen from fuel supplied by the fuel supply unit and supplying the hydrogen to the fuel cell stack.
